(19) United States
(12) Patent Application Publication
(10) Pub. No.: US 2026/0241685 A1
(43) Pub. Date: Aug. 20, 2026

(54) Liquid Discharge Apparatus And Control Method Of Liquid Discharge Apparatus

(71) Applicant: SEIKO EPSON CORPORATION, Tokyo (JP)

(72) Inventors: Shotaro WATANABE, Suwa (JP); Kenichiro MATSUO, Matsumoto (JP); Yoshitaka MATSUBARA, Shiojiri (JP); Takahiro KATAKURA, Okaya (JP); Naoki TAKAHASHI, Shiojiri (JP); Yuki WATANABE, Matsumoto (JP)

(21) Appl. No.: 19/541,903

(22) Filed: Feb. 17, 2026

(30) Foreign Application Priority Data
Feb. 18, 2025 (JP) 2025-024029

(51) Int. Cl. B41J 2/045; B41J 2/14

(52) U.S. Cl. CPC B41J 2/0459; B41J 2/04541; B41J 2/04573; B41J 2/04581; B41J 2/04588; B41J 2/04593; B41J 2/04596; B41J 2/14233; B41J 2002/14491

(57) ABSTRACT

A liquid discharge apparatus comprises a plurality of discharge sections each including a piezoelectric element having a first electrode, a second electrode, and a piezoelectric layer. The first electrode is supplied a first signal that maintains a potential at a first potential. The second electrode is supplied a second drive signal when the liquid is not discharged from the nozzle. The second drive signal includes: a first potential change element in which the potential changes from the reference potential to a second potential; and a second potential change element in which the potential changes from the second potential to the reference potential after a second potential maintenance element that maintains the potential at the second potential. The second potential is equal to or lower than the first potential and higher than a potential corresponding to a coercive electric field of the piezoelectric element.

The present application is based on, and claims priority from JP Application Serial Number 2025-024029, filed February 18, 2025, the disclosure of which is hereby incorporated by reference herein in its entirety.

### BACKGROUND

### Technical Field

The present disclosure relates to a liquid discharge apparatus and a control method of the liquid discharge apparatus.

### Related Art

A liquid discharge apparatus that prints an image by causing a plurality of nozzles to discharge a liquid such as ink by using a piezoelectric element is known. For example, a liquid discharge apparatus includes a liquid discharge head including a plurality of discharge sections. Each of the discharge sections includes a nozzle that discharges ink, a pressure chamber that communicates with the nozzle, and a piezoelectric element that applies a pressure fluctuation to the ink in the pressure chamber according to a drive signal. In this type of liquid discharge apparatus, a drive method of supplying a micro-vibration pulse that applies the pressure fluctuation to the ink in the pressure chamber without discharging the ink from the nozzle to a piezoelectric element corresponding to a nozzle that does not discharge the ink is proposed. For example, JP-A-2010-125707 discloses a liquid discharge apparatus that supplies a preliminary vibration drive pulse for generating pressure vibration to a piezoelectric element that corresponds to a nozzle that does not discharge ink, to the extent that the ink is not discharged from the nozzle.

Meanwhile, in a non-discharging drive signal supplied to the piezoelectric element corresponding to the nozzle that does not discharge the ink, a period during which the potential is maintained at the reference potential is long. Therefore, in the piezoelectric element to which the non-discharging drive signal is supplied with a high frequency, the deterioration of displacement characteristics of the piezoelectric element tends to progress as compared with the piezoelectric element to which a discharging drive signal is supplied with a high frequency. Therefore, in the liquid discharge apparatus, it is desirable to suppress a change in the displacement characteristics of the piezoelectric element corresponding to the nozzle with a low frequency of liquid discharge.

### SUMMARY

In order to solve the above-described problems, a liquid discharge apparatus according to the present disclosure includes a liquid discharge head that includes a plurality of discharge sections each including a nozzle that discharges liquid, a pressure chamber that communicates with the nozzle, and a piezoelectric element that applies a pressure fluctuation to the liquid in the pressure chamber in response to a drive signal, and a drive signal generation section that generates the drive signal, in which the piezoelectric element includes a first electrode to which a first signal that maintains a potential at a first potential is supplied, a second electrode to which the drive signal is supplied, and a piezoelectric layer disposed between the first electrode and the second electrode, the drive signal includes a first drive signal that is supplied to the second electrode of the piezoelectric element of the discharge section that discharges the liquid from the nozzle, and a second drive signal that is supplied to the second electrode of the piezoelectric element of the discharge section that does not discharge the liquid from the nozzle, the first drive signal includes a discharge element that is an element of a potential change for displacing the piezoelectric element such that the liquid is discharged from the nozzle, the second drive signal includes a first potential maintenance element that maintains the potential at a reference potential, a first potential change element in which the potential changes from the reference potential to a second potential, the first potential change element being an element after the first potential maintenance element, a second potential maintenance element that maintains the potential at the second potential, the second potential maintenance element being an element after the first potential change element, and a second potential change element in which the potential changes from the second potential to the reference potential, the second potential change element being an element after the second potential maintenance element, and the second potential is equal to or lower than the first potential and higher than a potential corresponding to a coercive electric field of the piezoelectric element.

In addition, a control method of a liquid discharge apparatus according to the present disclosure is a control method of a liquid discharge apparatus including a liquid discharge head that includes a plurality of discharge sections each including a nozzle that discharges liquid, a pressure chamber that communicates with the nozzle, and a piezoelectric element that applies a pressure fluctuation to the liquid in the pressure chamber in response to a drive signal, and a drive signal generation section that generates the drive signal, in which the piezoelectric element includes a first electrode to which a first signal that maintains a potential at a first potential is supplied, a second electrode to which the drive signal is supplied, and a piezoelectric layer disposed between the first electrode and the second electrode, the drive signal includes a first drive signal that is supplied to the second electrode of the piezoelectric element of the discharge section that discharges the liquid from the nozzle, and a second drive signal that is supplied to the second electrode of the piezoelectric element of the discharge section that does not discharge the liquid from the nozzle, the first drive signal includes a discharge element that is an element of a potential change for displacing the piezoelectric element such that the liquid is discharged from the nozzle, the second drive signal includes a first potential maintenance element that maintains the potential at a reference potential, a first potential change element in which the potential changes from the reference potential to a second potential, the first potential change element being an element after the first potential maintenance element, a second potential maintenance element that maintains the potential at the second potential, the second potential maintenance element being an element after the first potential change element, and a second potential change element in which the potential changes from the second potential to the reference potential, the second potential change element being an element after the second potential maintenance element, and the second potential is equal to or lower than the first potential and higher than a potential corresponding to a coercive electric field of the piezoelectric element.

### BRIEF DESCRIPTION OF THE DRAWINGS

FIG. 1 is a block diagram illustrating an example of a configuration of a liquid discharge apparatus according to an embodiment of the present disclosure.

FIG. 2 is a configuration diagram schematically illustrating the liquid discharge apparatus.

FIG. 3 is an explanatory diagram for describing a schematic structure of a head unit.

FIG. 4 is a block diagram illustrating an example of a configuration of the head unit.

FIG. 5 is a timing chart illustrating an example of an operation of the liquid discharge apparatus in a unit period.

FIG. 6 is an explanatory diagram for describing a relationship between a strain of the piezoelectric element and an electric field intensity.

### DESCRIPTION OF EMBODIMENTS

Hereinafter, embodiments for carrying out the present disclosure will be described with reference to the accompanying drawings. However, in each drawing, a dimension and a scale of each section are appropriately different from actual ones. Further, since the embodiments which will be described below are suitable specific examples of the present disclosure, various technically preferable limitations are attached. However, the scope of the present disclosure is not limited to the embodiments unless the following description particularly limit the present disclosure.

### 1. Embodiment

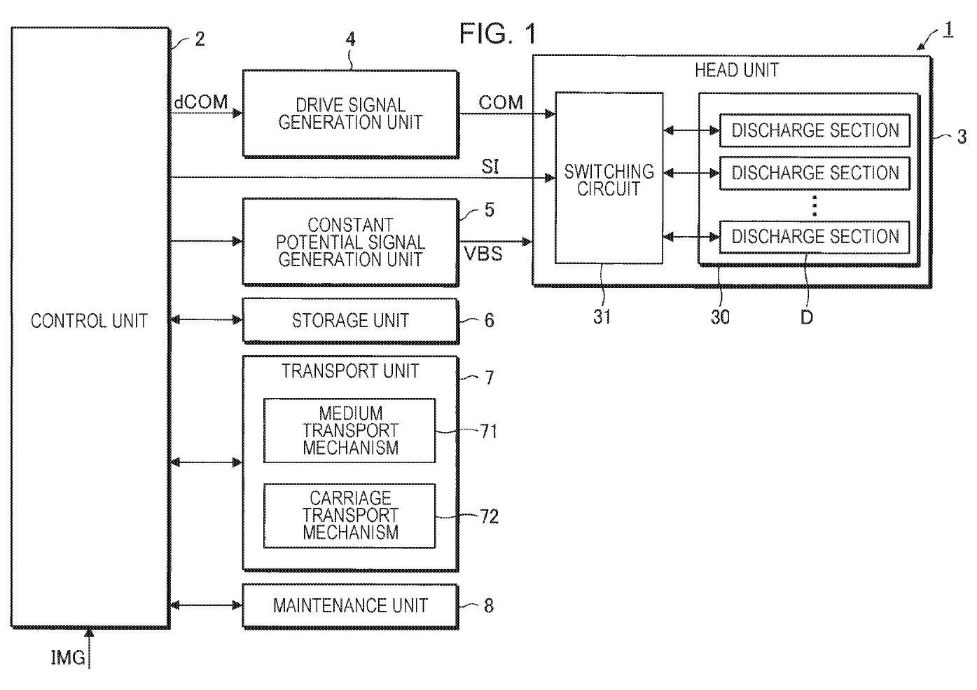

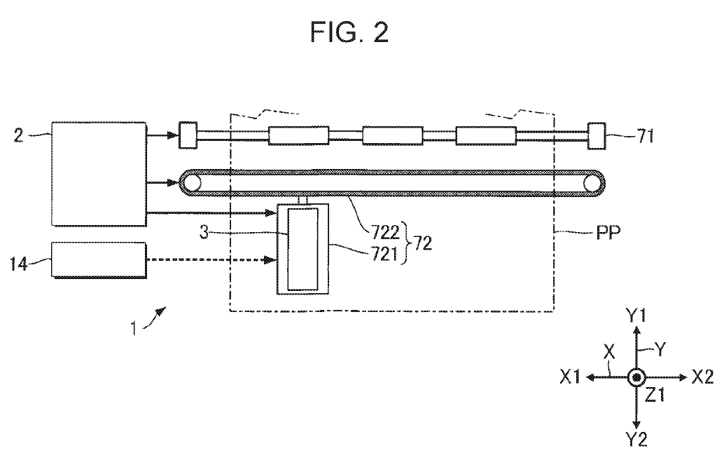

First, a configuration of a liquid discharge apparatus 1 according to the present embodiment will be described with reference to FIG. 1. In the present embodiment, a case where the liquid discharge apparatus 1 is an ink jet printer that discharges an ink to a medium to form an image is assumed as an example. In the present embodiment, the ink is an example of a "liquid". In the present embodiment, a recording paper sheet PP illustrated in FIG. 2 to be described below is assumed as the medium.

FIG. 1 is a block diagram illustrating an example of a configuration of the liquid discharge apparatus 1 according to the embodiment of the present disclosure.

For example, print data IMG indicating an image to be formed by the liquid discharge apparatus 1 is supplied to the liquid discharge apparatus 1 from a host computer such as a personal computer and a digital camera. The liquid discharge apparatus 1 performs a printing process of forming the image indicated by the print data IMG supplied from the host computer on the medium.

The liquid discharge apparatus 1 includes a control unit 2 that controls each unit of the liquid discharge apparatus 1 and a head unit 3 in which a discharge section D that discharges the ink is provided. In addition, the liquid discharge apparatus 1 includes a drive signal generation unit 4 that generates a plurality of drive signals COM for driving the discharge section D, and a constant potential signal generation unit 5 that generates a constant potential bias voltage signal VBS. Further, the liquid discharge apparatus 1 includes a storage unit 6 that stores various information such as print data IMG and a control program of the liquid discharge apparatus 1. Further, the liquid discharge apparatus 1 includes a transport unit 7 for changing a relative position of the recording paper sheet PP with respect to the head unit 3, and a maintenance unit 8 that executes a maintenance process for maintaining the discharge section D provided in the head unit 3. The head unit 3 is an example of a "liquid discharge head", and the drive signal generation unit 4 is an example of a "drive signal generation section".

In the present embodiment, it is assumed that the head unit 3 and the drive signal generation unit 4 correspond to each other. For example, the liquid discharge apparatus 1 may include the plurality of head units 3 and the plurality of drive signal generation units 4 that correspond to the plurality of head units 3 on a one-to-one basis. Alternatively, the liquid discharge apparatus 1 may include one head unit 3 and one drive signal generation unit 4 corresponding to the one head unit 3.

In the present embodiment, it is assumed that the liquid discharge apparatus 1 includes four head units 3 and four drive signal generation units 4 that correspond to the four head units 3 on a one-to-one basis. However, hereinafter, for convenience of description, as illustrated in FIG. 1, there is a case where a description will be given by focusing on one head unit 3 among the four head units 3 and one drive signal generation unit 4 provided corresponding to one head unit 3 among the four drive signal generation units 4.

The control unit 2 is configured with one or a plurality of central processing units (CPU). The control unit 2 may be configured with a programmable logic device such as a field-programmable gate array (FPGA), instead of the CPU or in addition to the CPU. Further, the control unit 2 generates a signal for controlling an operation of each section of the liquid discharge apparatus 1, such as a print signal SI and a waveform designation signal dCOM, by operating according to a control program stored in the storage unit 6.

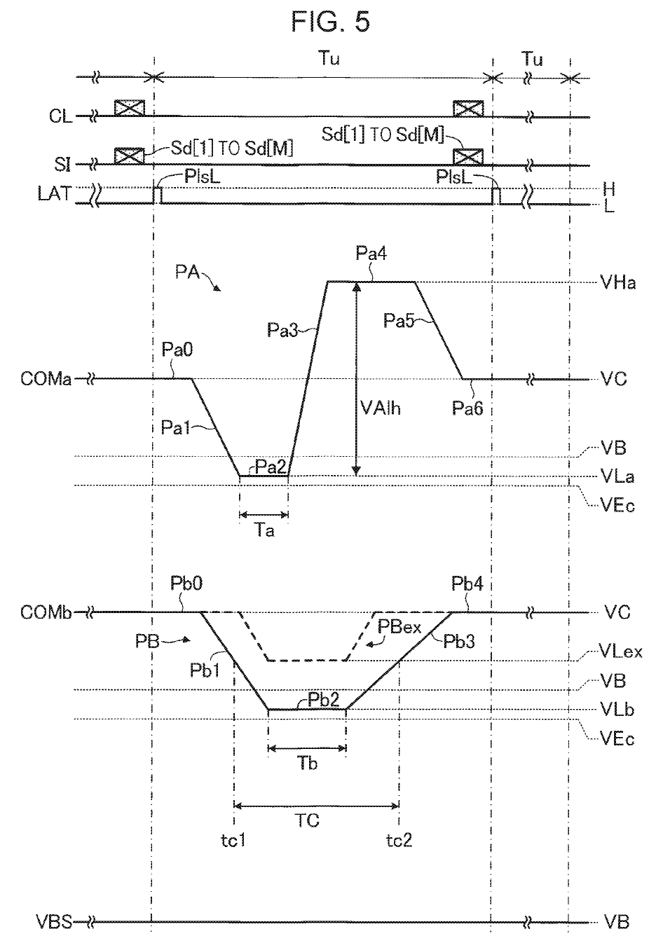

Herein, the waveform designation signal dCOM is a digital signal that defines each of waveforms of the plurality of drive signals COM. In addition, each drive signal COM is an analog signal for driving the discharge section D. In the present embodiment, as illustrated in FIG. 5 and the like to be described below, it is assumed that the plurality of drive signals COM include a drive signal COMa, a drive signal COMb, and the like. The print signal SI is a digital signal for designating a type of operation of the discharge section D. Specifically, the print signal SI is a signal for designating the type of operation of the discharge section D by designating whether or not to supply each drive signal COM to the discharge section D.

The drive signal generation unit 4 includes, for example, a digital analog converter (DAC), and generates the plurality of drive signals COM based on the waveform designation signal dCOM supplied from the control unit 2. For example, each of the plurality of drive signals COM generated by the drive signal generation unit 4 includes a waveform defined by the waveform designation signal dCOM. The drive signal generation unit 4 outputs the plurality of drive signals COM generated based on the waveform designation signal dCOM to a switching circuit 31 included in the head unit 3.

The constant potential signal generation unit 5 is, for example, a power supply circuit that receives a supply of electric power from a commercial power supply (not shown) and generates predetermined various potentials. The various potentials generated by the constant potential signal generation unit 5 are appropriately supplied to each unit of the liquid discharge apparatus 1. For example, the constant potential signal generation unit 5 generates the constant potential bias voltage signal VBS and supplies the generated bias voltage signal VBS to the head unit 3. As a result, a potential VB shown in FIG. 5, which is the potential of the bias voltage signal VBS, is supplied to the discharge section D. The potential VB is an example of a "first potential", and the bias voltage signal VBS is an example of a "first signal". The constant potential signal generation unit 5 may be included in the control unit 2 or may be included in the drive signal generation unit 4.

The storage unit 6 is configured to include one or both of a volatile memory such as a random access memory (RAM), and a non-volatile memory such as a read only memory (ROM), an electrically erasable programmable read-only memory (EEPROM), or a programmable ROM (PROM). The storage unit 6 may be included in the control unit 2.

The head unit 3 includes a recording head 30 and a switching circuit 31.

The recording head 30 includes M discharge sections D. A value of M is a natural number of 3 or more. Hereinafter, among the M discharge sections D provided in the recording head 30, an m-th discharge section D may be referred to as a discharge section D[m]. In this case, the variable m is a natural number that satisfies "3 ≤ m ≤ M". In addition, hereinafter, when a component, a signal, or the like of the liquid discharge apparatus 1 corresponds to the discharge section D[m] among the M discharge sections D, a suffix [m] may be added to reference numerals for representing the component, the signal, or the like.

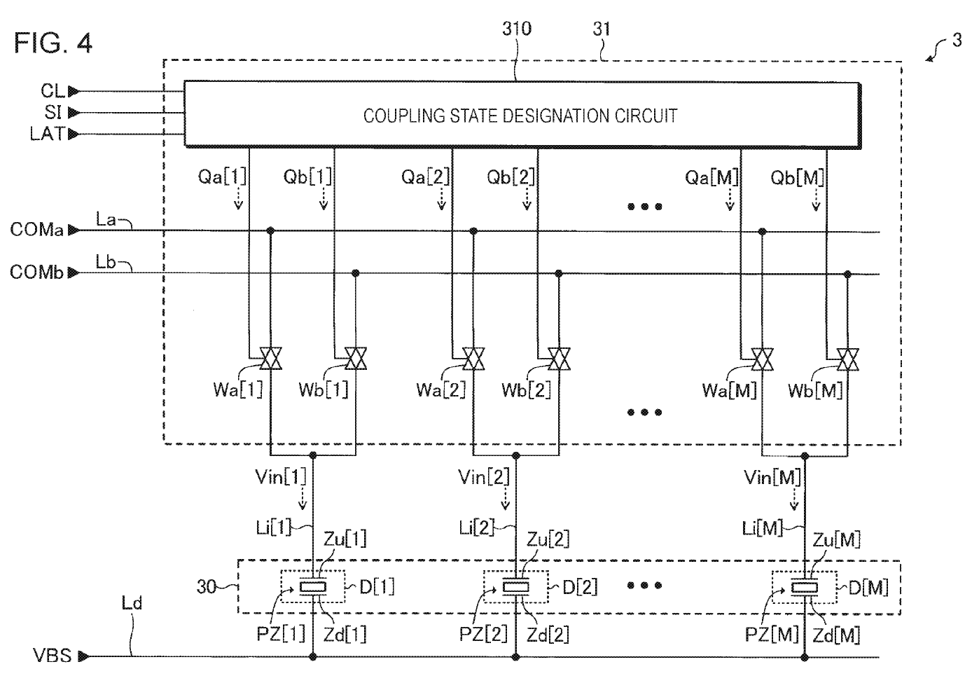

The switching circuit 31 switches whether or not to supply each drive signal COM to the discharge section D[m], based on the print signal SI. Hereinafter, as illustrated in FIG. 4 and the like to be described later, the drive signal COM supplied to the discharge section D[m] among the plurality of drive signals COM will be referred to as an individual drive signal Vin[m] in some cases.

As described above, in the present embodiment, the liquid discharge apparatus 1 executes the printing process. When the printing process is executed, the control unit 2 generates a signal for controlling the head unit 3 such as the print signal SI based on the print data IMG. In addition, the control unit 2 generates a signal for controlling the drive signal generation unit 4, such as the waveform designation signal dCOM, when the printing process is executed. In addition, the control unit 2 generates a signal for controlling the transport unit 7 when the printing process is executed. Therefore, in the printing process, the control unit 2 adjusts the presence or absence of discharge of inks from the discharge section D[m], the discharge amount of inks, a discharge timing of the inks, and the like while controlling the transport unit 7 to change a relative position of the recording paper sheet PP with respect to the head unit 3. As described above, the control unit 2 controls each section of the liquid discharge apparatus 1 so that an image corresponding to the print data IMG is formed at the recording paper sheet PP.

The transport unit 7 includes a carriage transport mechanism 72 for reciprocating a carriage 721 and a medium transport mechanism 71 for transporting the recording paper sheet PP. The carriage 721 will be described below in FIG. 2.

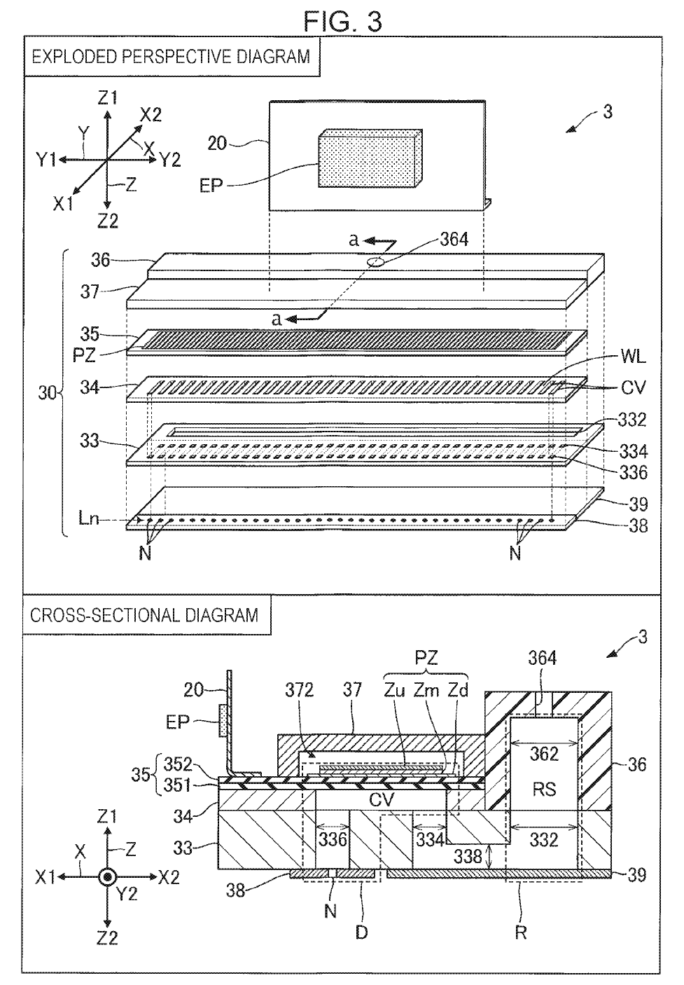

Further, as described above, in the present embodiment, the liquid discharge apparatus 1 executes the maintenance process. For example, the maintenance process includes flushing processing of discharging inks from the discharge section D, wiping processing of wiping off a foreign matter such as an ink adhering to the vicinity of a nozzle N of the discharge section D with a wiper, and pumping processing of suctioning the ink in the discharge section D with a tube pump or the like. The nozzle N will be described below in FIG. 3.

The maintenance unit 8 includes a discharged ink receiving section for receiving the discharged ink when the ink in the discharge section D is discharged, a wiper for wiping off a foreign matter such as an ink adhering to the vicinity of the nozzle N of the discharge section D, and a tube pump for suctioning the ink, air bubbles, and the like in the discharge section D, in the flushing processing. The discharged ink receiving section, the wiper, and the tube pump are not illustrated.

Next, a schematic overall configuration of the liquid discharge apparatus 1 will be described with reference to FIG. 2.

FIG. 2 is a configuration diagram schematically illustrating the liquid discharge apparatus 1. As illustrated in FIG. 2, in the present embodiment, it is assumed that the liquid discharge apparatus 1 is a serial printer as an example.

As illustrated in FIG. 2, the liquid discharge apparatus 1 includes a liquid container 14 that stores ink, in addition to the elements described in FIG. 1. As the liquid container 14, for example, a cartridge that can be attached to and detached from the liquid discharge apparatus 1, a bag-shaped ink pack formed of a flexible film, an ink tank that can be replenished with ink, or the like can be employed. A type of ink to be stored in the liquid container 14 is not particularly limited, and is selected in any desired way.

The medium transport mechanism 71 transports the recording paper sheet PP in a Y2 direction along a Y axis under the control of the control unit 2. Hereinafter, a Y1 direction and the Y2 direction opposite to the Y1 direction are collectively referred to as a direction along the Y axis. In addition, hereinafter, an X1 direction along an X axis that intersects the Y axis and an X2 direction opposite to the X1 direction are collectively referred to as a direction along the X axis. In addition, hereinafter, a Z1 direction along a Z axis that intersects the X axis and the Y axis and a Z2 direction opposite to the Z1 direction are collectively referred to as a direction along the Z axis. In the present embodiment, as an example, description will be performed while assuming that the X axis, the Y axis, and the Z axis are orthogonal to each other. However, the present disclosure is not limited to such an aspect. The X axis, the Y axis, and the Z axis may intersect each other. In the present embodiment, the Z2 direction corresponds to an ink discharge direction from the discharge section D[m].

The carriage transport mechanism 72 reciprocates the head unit 3 in the X1 direction and the X2 direction under the control of the control unit 2. As illustrated in FIG. 2, the carriage transport mechanism 72 includes the substantially box-shaped carriage 721 accommodating the head unit 3 and an endless belt 722 to which the carriage 721 is fixed. The liquid container 14 may be stored in the carriage 721 together with the head unit 3.

Next, a schematic structure of the head unit 3 will be described with reference to FIG. 3.

FIG. 3 is an explanatory diagram for describing the schematic structure of the head unit 3. The upper part of FIG. 3 is an exploded perspective diagram of the head unit 3, and the lower part of FIG. 3 is a cross-sectional diagram taken along the line a-a illustrated in the exploded perspective diagram. The a-a cross section is parallel to the XZ plane, and passes through an introduction port 364 described below.

As illustrated in FIG. 3, the head unit 3 includes a wiring substrate 20 on which an electronic component EP is mounted, a flow path substrate 33, a pressure chamber substrate 34, a vibration plate 35, and M piezoelectric elements PZ, a case 36, a sealing plate 37, a nozzle substrate 38, and a vibration absorber 39. The electronic component EP includes, for example, an electric circuit such as the switching circuit 31. For example, the recording head 30 is electrically coupled to the switching circuit 31 or the like via the wiring substrate 20. As illustrated in the exploded perspective diagram of FIG. 3, the recording head 30 includes, for example, a flow path substrate 33, a pressure chamber substrate 34, a vibration plate 35, M piezoelectric elements PZ, a case 36, a sealing plate 37, a nozzle substrate 38, and a vibration absorber 39.

Here, the pressure chamber substrate 34, the vibration plate 35, the M piezoelectric elements PZ, the case 36, and the sealing plate 37 are installed in a region located in the Z1 direction from the flow path substrate 33. On the other hand, the nozzle substrate 38 and the vibration absorber 39 are installed in a region located in the Z2 direction from the flow path substrate 33. In addition, the wiring substrate 20 is provided on a surface of the vibration plate 35 in the Z1 direction, for example. Each element of the head unit 3 is generally a plate-shaped member elongated in the direction along the Y axis, and is joined to each other with an adhesive, for example.

As illustrated in the exploded perspective diagram of FIG. 3, the nozzle substrate 38 is a plate-shaped member in which M nozzles N arranged along the Y axis are formed. Each of the nozzles N is a through-hole through which ink passes. The flow path substrate 33, the pressure chamber substrate 34, and the nozzle substrate 38 are formed by processing, for example, a silicon single crystal substrate by a semiconductor manufacturing technology such as etching. Meanwhile, a material or a manufacturing method of each element of the head unit 3 is optional. The direction of the Y axis can also be referred to as a direction in which the M nozzles N are arranged. Hereinafter, the M nozzles N arranged along the Y axis are referred to as a nozzle row Ln.

The flow path substrate 33 is a plate-shaped member for forming a flow path for inks. As illustrated in FIG. 3, the flow path substrate 33 is formed with an opening portion 332, M supply flow paths 334, and M communication flow paths 336. The opening section 332 is a through-hole that is continuous over the M nozzles N along the Y axis in a plan view from the direction along the Z axis. That is, the opening section 332 is a long through-hole extending in the direction along the Y axis. The supply flow path 334 and the communication flow path 336 are through-holes individually formed for each of the nozzles N. As illustrated in the cross-sectional diagram in FIG. 3, a relay flow path 338 over the M supply flow paths 334 is formed at a surface of the flow path substrate 33 in the Z2 direction. The relay flow path 338 is a flow path that allows the opening section 332 and the M supply flow paths 334 to communicate with each other.

The pressure chamber substrate 34 is a plate-shaped member in which M pressure chambers CV respectively corresponding to the M nozzles N are formed. The pressure chamber CV is located between the flow path substrate 33 and the vibration plate 35, and is a space called a cavity for applying pressure to an ink filled in the pressure chamber CV. The M pressure chambers CV are partitioned by the partition wall WL of the pressure chamber substrate 34 and are arranged in the direction along the Y axis. Each pressure chamber CV is configured with a hole that opens at both surfaces of the pressure chamber substrate 34, and has a long shape extending in the direction along the X axis. An end of each pressure chamber CV in the X2 direction communicates with the corresponding supply flow path 334 among the M supply flow paths 334. On the other hand, an end of each pressure chamber CV in the X1 direction communicates with the corresponding communication flow path 336 among the M communication flow paths 336.

The vibration plate 35 is installed on a surface of the pressure chamber substrate 34 in a direction opposite to a surface facing the flow path substrate 33. The vibration plate 35 is a plate-shaped member that is elastically deformable. As illustrated in the cross-sectional diagram of FIG. 3, the vibration plate 35 includes an insulating film 352 and an elastic film 351 laminated in the direction along the Z axis. The insulating film 352 is located in a direction opposite to the pressure chamber substrate 34 when viewed from the elastic film 351. The elastic film 351 is formed of, for example, silicon oxide. The insulating film 352 is formed of, for example, zirconium oxide.

As can be understood from FIG. 3, the flow path substrate 33 and the vibration plate 35 face each other at an interval inside each of the pressure chambers CV. The vibration plate 35 forms a part of a wall surface of the pressure chamber CV. An ink stored in a liquid storage chamber RS which will be described later branches from the relay flow path 338 to each supply flow path 334, and is supplied to and filled into the M pressure chambers CV in parallel.

As illustrated in FIG. 3, the M piezoelectric elements PZ respectively corresponding to the M nozzles N are installed on a surface of the vibration plate 35 in a direction opposite to the pressure chamber substrate 34. For example, for any m from 1 to M, the nozzle N[m] corresponds to the piezoelectric element PZ[m]. The nozzle N corresponding to the piezoelectric element PZ is the nozzle N communicating with the pressure chamber CV that partially or entirely overlaps with the piezoelectric element PZ in a plan view in the Z2 direction. Each of the piezoelectric elements PZ is an actuator that is deformed by the supply of the drive signal COM, and is formed in a long shape in a direction along the X axis. The M piezoelectric elements PZ are arranged in the direction along the Y axis to correspond to the M pressure chambers CV. When the drive signal COM is supplied to the piezoelectric element PZ and the vibration plate 35 vibrates in conjunction with deformation of the piezoelectric element PZ, pressure in the pressure chamber CV fluctuates. As the pressure in the pressure chamber CV fluctuates, the ink filled in the pressure chamber CV passes through the communication flow path 336 and the nozzle N, and is discharged. That is, the piezoelectric element PZ is a drive element that discharges the ink in the pressure chamber CV from the nozzle N by vibrating the vibration plate 35.

In the present embodiment, as illustrated in FIG. 5 which will be described later, the drive signal COMb for not discharging the ink in the nozzle N is supplied to the piezoelectric element PZ corresponding to the nozzle N that does not discharge the ink. When the drive signal COMb is supplied to the piezoelectric element PZ, the vibration plate 35 vibrates in conjunction with the deformation of the piezoelectric element PZ and the pressure in the pressure chamber CV fluctuates. As a result, the ink in the nozzle N is stirred, and the thickening of the ink is suppressed. However, in the deformation of the piezoelectric element PZ by the drive signal COMb, the ink in the nozzle N only vibrates, and the ink is not discharged from the nozzle N. In the following description, the vibration that causes the ink in the nozzle N to vibrate to the extent that the ink in the nozzle N is not discharged may be described as a micro-vibration.

As illustrated in the cross-sectional diagram of FIG. 3, the piezoelectric element PZ has an upper electrode Zu, a lower electrode Zd, and a piezoelectric layer Zm provided between the upper electrode Zu and the lower electrode Zd. The piezoelectric layer Zm is formed of, for example, a ferroelectric piezoelectric material. In addition, for example, the drive signal COM is supplied to the upper electrode Zu, and a bias voltage signal VBS that maintains the potential at the potential VB is supplied to the lower electrode Zd. In this case, the lower electrode Zd is an example of a "first electrode", and the upper electrode Zu is an example of a "second electrode". Further, the pressure chamber CV is provided in the Z2 direction of a piezoelectric element PZ.

In the cross-sectional diagram of FIG. 3, in order to avoid the drawing from being complicated, a wiring which is coupled to the upper electrode Zu and supplies the drive signal COM to the upper electrode Zu, and a wiring which is coupled to the lower electrode Zd and supplies the bias voltage signal VBS to the lower electrode Zd are not illustrated. In the present embodiment, a case is assumed in which the drive signal COM is supplied to the upper electrode Zu and the bias voltage signal VBS is supplied to the lower electrode Zd. Meanwhile, the bias voltage signal VBS may be supplied to the upper electrode Zu and the drive signal COM may be supplied to the lower electrode Zd. In this case, the upper electrode Zu corresponds to the "first electrode", and the lower electrode Zd corresponds to the "second electrode".

Here, in the present embodiment, as an example, it is assumed that the piezoelectric element PZ is displaced in the Z2 direction by changing a potential of the individual drive signal Vin[m] supplied to the discharge section D[m] from a low potential to a high potential. That is, in the present embodiment, it is assumed that the volume of the pressure chamber CV provided in the discharge section D[m] is decreased when the potential of the individual drive signal Vin[m] supplied to the discharge section D[m] is high, in comparison with a case where the potential is low.

As illustrated in FIG. 3, the case 36 is, for example, a structure manufactured by injection molding of a resin material, and is fixed to a surface of the flow path substrate 33 in the Z1 direction. As illustrated in the cross-sectional diagram of FIG. 3, the case 36 is formed with an accommodation section 362 and an introduction port 364. The accommodation section 362 is a recess section having a shape corresponding to the opening section 332 of the flow path substrate 33. The introduction port 364 is a through-hole that communicates with the accommodation section 362. A space of the opening section 332 of the flow path substrate 33 and the accommodation section 362 of the case 36 functions as the liquid storage chamber RS which is a reservoir which stores inks to be supplied to the M pressure chambers CV. The ink supplied from the liquid container 14 and passing through the introduction port 364 is stored in the liquid storage chamber RS.

The sealing plate 37 has a structure that protects the M piezoelectric elements PZ from the outside air and reinforces the mechanical strength of the pressure chamber substrate 34 and the vibration plate 35. The sealing plate 37 is fixed to a surface of the vibration plate 35 with, for example, an adhesive. As illustrated in the cross-sectional diagram of FIG. 3, the sealing plate 37 has a recess section on a surface facing the vibration plate 35. A sealing space 372 is formed by fixing the sealing plate 37 to the surface of the vibration plate 35. The M piezoelectric elements PZ are provided in the sealing space 372.

The vibration absorber 39 absorbs the pressure fluctuation in the liquid storage chamber RS. That is, the vibration absorber 39 absorbs the vibration of the inks stored in the liquid storage chamber RS. For example, the vibration absorber 39 includes a flexible sheet member that can be elastically deformed. Specifically, the vibration absorber 39 is installed on a surface of the flow path substrate 33 in the Z2 direction so that a bottom surface of the liquid storage chamber RS is formed by closing the opening section 332 of the flow path substrate 33, the relay flow path 338, and the plurality of supply flow paths 334.

Next, an outline of the head unit 3 will be described with reference to FIG. 4.

FIG. 4 is a block diagram illustrating an example of a configuration of the head unit 3.

As described in FIG. 1, the head unit 3 includes a recording head 30 and a switching circuit 31. In addition, the head unit 3 includes a wiring La to which the drive signal COMa is supplied from the drive signal generation unit 4, a wiring Lb to which the drive signal COMb is supplied from the drive signal generation unit 4, and a wiring Ld to which the bias voltage signal VBS is supplied from the constant potential signal generation unit 5. Further, the head unit 3 includes a wiring Li[m] that supplies the individual drive signal Vin[m] to the discharge section D[m]. The drive signal COMa is an example of a "first drive signal", and the drive signal COMb is an example of a "second drive signal".

The switching circuit 31 includes M switches Wa[1] to Wa[M] that correspond to the M discharge sections D[1] to D[M] in a one-to-one manner, M switches Wb[1] to Wb[M] that correspond to the M discharge sections D[1] to D[M] in a one-to-one manner, and a coupling state designation circuit 310. The coupling state designation circuit 310 designates a coupling state of each of the M switches Wa and the M switches Wb. For example, the coupling state designation circuit 310 generates coupling state designation signals Qa[m] and Qb[m] based on at least a part of the signals of the print signal SI and a latch signal LAT supplied from the control unit 2. The coupling state designation signal Qa[m] is a signal for designating ON or OFF of the switch Wa[m], and the coupling state designation signal Qb[m] is a signal for designating ON or OFF of the switch Wb[m].

The switch Wa[m] switches conduction and non-conduction between the wiring La and the upper electrode Zu[m] of the piezoelectric element PZ[m] provided in the discharge section D[m], based on the coupling state designation signal Qa[m]. That is, the switch Wa[m] switches conduction and non-conduction between the wiring La and the wiring Li[m] coupled to the upper electrode Zu[m], based on the coupling state designation signal Qa[m]. In the present embodiment, the switch Wa[m] is turned on when the coupling state designation signal Qa[m] is at a high level, and is turned off when the coupling state designation signal Qa[m] is at a low level. When the switch Wa[m] is turned on, the drive signal COMa supplied to the wiring La is supplied to the upper electrode Zu[m] of the discharge section D[m] as the individual drive signal Vin[m] via the wiring Li[m].

The switch Wb[m] switches conduction and non-conduction between the wiring Lb and the upper electrode Zu[m] of the piezoelectric element PZ[m] provided in the discharge section D[m], based on the coupling state designation signal Qb[m]. That is, the switch Wb[m] switches conduction and non-conduction between the wiring Lb and the wiring Li[m] coupled to the upper electrode Zu[m], based on the coupling state designation signal Qb[m]. In the present embodiment, the switch Wb[m] is turned on when the coupling state designation signal Qb[m] is at a high level, and is turned off when the coupling state designation signal Qb[m] is at a low level. When the switch Wb[m] is turned on, the drive signal COMb supplied to the wiring Lb is supplied to the upper electrode Zu[m] of the discharge section D[m] as the individual drive signal Vin[m] via the wiring Li[m].

As described above, the individual drive signal Vin[m] is a signal supplied to the piezoelectric element PZ[m] of the discharge section D[m] via the switch Wa[m] or Wb[m] among the drive signals COMa and COMb.

Next, an operation of the liquid discharge apparatus 1 in a unit period Tu will be described with reference to FIG. 5.

FIG. 5 is a timing chart illustrating an example of the operation of the liquid discharge apparatus 1 in the unit period Tu. In the present embodiment, when the liquid discharge apparatus 1 performs the printing process, a printing process period including one or a plurality of unit periods Tu is set as an operation period of the liquid discharge apparatus 1. The liquid discharge apparatus 1 according to the present embodiment can drive each discharge section D for the printing process in each unit period Tu. The unit period Tu is, for example, a drive cycle of the M discharge sections D. In the present embodiment, it is assumed that one cycle of the plurality of drive signals COM is the unit period Tu. In addition, in FIG. 5, a pulse PBex that generates micro-vibration as a comparative example to the pulse PB of the drive signal COMb is shown by a broken line.

The control unit 2 outputs the latch signal LAT having a pulse PlsL. Therefore, the control unit 2 defines the unit period Tu as a period from rising of the pulse PlsL to rising of the next pulse PlsL.

The print signal SI includes, for example, M individual designation signals Sd[1] to Sd[M] corresponding to the M discharge sections D[1] to D[M] on a one-to-one basis. The individual designation signal Sd[m] designates an aspect of driving of the discharge section D[m] in each unit period Tu when the liquid discharge apparatus 1 performs the printing process.

The control unit 2 supplies the print signal SI including the individual designation signals Sd[1] to Sd[M] to the coupling state designation circuit 310 in synchronization with a clock signal CL before each unit period Tu in which the printing process is executed. The coupling state designation circuit 310 generates the coupling state designation signals Qa[m] and Qb[m] based on the individual designation signal Sd[m] in the unit period Tu.

For example, by the individual designation signal Sd[m], the discharge section D[m] is designated to any one of the discharge section D that forms dots and the discharge section D that does not form dots in the unit period Tu in which the printing process is executed. The discharge section D that forms a dot is the discharge section D in which the piezoelectric element PZ of the discharge section D is driven so that an ink is discharged from the nozzle N of the discharge section D. In addition, the discharge section D that does not form a dot is the discharge section D in which the piezoelectric element PZ of the discharge section D is driven so that the ink is not discharged from the nozzle N of the discharge section D. In the discharge section D[m] that forms a dot, that is, the discharge section D[m] that discharges the ink from the nozzle N, the drive signal COMa is supplied to the upper electrode Zu of the piezoelectric element PZ as the individual drive signal Vin[m]. In addition, in the discharge section D[m] that does not form a dot, that is, the discharge section D[m] that does not discharge the ink from the nozzle N, the drive signal COMb is supplied to the upper electrode Zu of the piezoelectric element PZ as the individual drive signal Vin[m].

First, an outline of the drive signal COMa will be described.

The drive signal COMa includes a pulse PA, a waveform element Pa0 which is an element before the pulse PA, and a waveform element Pa6 which is an element after the pulse PA. For example, when the drive signal COMa is supplied to the wiring La, the waveform element Pa0, the pulse PA, and the waveform element Pa6 are supplied to the wiring La in the unit period Tu.

For example, the waveform element Pa0 is an element that maintains the potential of the drive signal COMa at the reference potential VC from the start of the unit period Tu to the start of the pulse PA. In addition, the waveform element Pa6 is an element that maintains the potential of the drive signal COMa at the reference potential VC from the end of the pulse PA until the end of the unit period Tu.

The pulse PA is a pulse in which the potential of the drive signal COMa returns from the reference potential VC to the reference potential VC via the potential VLa and the potential VHa. The potential VLa is a potential lower than the reference potential VC, and is the lowest potential of the pulse PA. The potential VHa is a potential higher than the reference potential VC and is the highest potential of the pulse PA. That is, the reference potential VC is a potential between the potential VLa and the potential VHa. In addition, the reference potential VC is a potential higher than the potential VB supplied to the lower electrode Zd of the piezoelectric element PZ. Each of the reference potential VC, the potential VLa, and the potential VHa is determined based on, for example, the ink discharge characteristic by the discharge section D. Examples of the ink discharge characteristic include the amount of ink to be discharged and the speed of ink to be discharged. For example, the potential VLa is a potential higher than a potential VEc corresponding to the coercive electric field of the piezoelectric element PZ, and is a potential equal to or lower than the potential VB supplied to the lower electrode Zd of the piezoelectric element PZ. The coercive electric field of the piezoelectric element PZ is, for example, a magnitude of an electric field when the polarization of the ferroelectric material is reversed. The potential VLa is an example of a "third potential".

In addition, the pulse PA includes, for example, waveform elements Pa1, Pa2, Pa3, Pa4, and Pa5.

The waveform element Pa1 is an element after the waveform element Pa0, and is an expansion element for displacing the piezoelectric element PZ in the Z1 direction. In the expansion element, the potential of the drive signal COMa changes to expand a volume of the pressure chamber CV. For example, in the waveform element Pa1, the potential of the drive signal COMa changes from the reference potential VC to the potential VLa to drive the piezoelectric element PZ so as to expand the volume of the pressure chamber CV. When the volume of the pressure chamber CV expands, a surface of an ink in the nozzle N is pulled in the Z1 direction, which is a direction opposite to the discharge direction. Hereinafter, the pulling of the surface of the ink in the nozzle N in the direction opposite to the discharge direction may be referred to as a pull. In addition, hereinafter, the surface of the ink in the nozzle N may be referred to as a meniscus. The waveform element Pa1 is an example of a "third potential change element". As can be understood from FIG. 5, the waveform element Pa1 is an element before the waveform element Pa3.

The waveform element Pa2 is an element after the waveform element Pa1, and is a maintenance element for maintaining the position of the piezoelectric element PZ in the direction along the Z axis. For example, in the waveform element Pa2, the potential of the drive signal COMa is maintained in order to drive the piezoelectric element PZ so that the volume of the pressure chamber CV expanded by the waveform element Pa1 is maintained. Therefore, in the waveform element Pa2, the potential of the drive signal COMa is maintained at the potential VLa, which is the potential of the end point of the waveform element Pa1. The waveform element Pa2 is an example of a "third potential maintenance element".

The waveform element Pa3 is an element after the waveform element Pa2, and is a contraction element for displacing the piezoelectric element PZ in the Z2 direction. In the contraction element, the potential of the drive signal COMa changes to contract the volume of the pressure chamber CV. For example, in the waveform element Pa3, the potential of the drive signal COMa changes from the potential VLa to the potential VHa to drive the piezoelectric element PZ to contract the volume of the pressure chamber CV. When the volume of the pressure chamber CV is contracted, the surface of the ink in the nozzle N is pushed out in the Z2 direction, which is the discharge direction. As a result, the ink is discharged from the nozzle N. Hereinafter, the act of pushing the surface of the ink in the nozzle N in the discharge direction may be referred to as a push. The waveform element Pa3 is an example of a "discharge element".

The waveform element Pa4 is a maintenance element after the waveform element Pa3. For example, in the waveform element Pa4, the potential of the drive signal COMa is maintained at the potential VHa of the end point of the waveform element Pa3 to drive the piezoelectric element PZ to maintain the volume of the pressure chamber CV that is contracted by the waveform element Pa3.

The waveform element Pa5 is an expansion element after the waveform element Pa4. For example, in the waveform element Pa5, the potential of the drive signal COMa changes from the potential VHa to the reference potential VC to expand the volume of the pressure chamber CV maintained by the waveform element Pa4 to attenuate the residual vibration of the ink in the pressure chamber CV. The volume of the pressure chamber CV maintained by the waveform element Pa4 corresponds to the volume of the pressure chamber CV contracted by the waveform element Pa3.

Next, an outline of the drive signal COMb will be described.

The drive signal COMb includes a pulse PB, a waveform element Pb0 which is an element before the pulse PB, and a waveform element Pb4 which is an element after the pulse PB. For example, when the drive signal COMb is supplied to the wiring Lb, the waveform element Pb0, the pulse PB, and the waveform element Pb4 are supplied to the wiring Lb in the unit period Tu.

For example, the waveform element Pb0 is an element that maintains the potential of the drive signal COMb at the reference potential VC from the start of the unit period Tu to the start of the pulse PB. In addition, the waveform element Pb4 is an element that maintains the potential of the drive signal COMb at the reference potential VC from the end of the pulse PB until the end of the unit period Tu. The waveform element Pb0 is an example of the "first potential maintenance element".

The pulse PB is a pulse in which the potential of the drive signal COMb returns from the reference potential VC to the reference potential VC via the potential VLb. The potential VLb is a potential lower than the reference potential VC, and is the lowest potential of the pulse PB. For example, the potential VLa is a potential higher than a potential VEc corresponding to the coercive electric field of the piezoelectric element PZ and equal to or lower than the potential VB supplied to the lower electrode Zd of the piezoelectric element PZ. The potential VLb is an example of the "second potential".

Here, in the pulse PBex of the comparative example, the lowest potential of the pulse PBex is a potential VLex higher than the potential VB. That is, in the pulse PBex of the comparative example, a change amount from the reference potential VC is smaller than that in the pulse PB. Therefore, in the piezoelectric element PZ to which the pulse PBex of the comparative example is supplied, the displacement from the state of the piezoelectric element PZ to which the pulse PB is supplied is smaller than that in the piezoelectric element PZ to which the reference potential VC is supplied. As a result, in the aspect in which the pulse PBex of the comparative example is used, the period during which the piezoelectric element PZ corresponding to the nozzle N with a low frequency of ink discharging is maintained in a state of having no or small displacement from the state when the reference potential VC is supplied is long. In this case, the displacement characteristics of the piezoelectric element PZ corresponding to the nozzle N with a low frequency of ink discharging may deteriorate due to so-called imprinting in which the polarization of the ferroelectric material is biased.

On the other hand, in the present embodiment, as described above, the potential VLb, which is the lowest potential of the pulse PB, is set to the potential VB or less. For example, the pulse PB includes a waveform element Pb2 that maintains the potential of the drive signal COMb at the potential VLb. As a result, in the present embodiment, it is possible to suppress the period during which the piezoelectric element PZ corresponding to the nozzle N with a low frequency of ink discharging is maintained in a state of having no or small displacement from the state when the reference potential VC is supplied from being long. As a result, in the present embodiment, it is possible to suppress the deterioration of the displacement characteristics of the piezoelectric element PZ corresponding to the nozzle N with a low frequency of ink discharging due to the imprinting.

In the example illustrated in FIG. 5, the pulse PB includes the waveform elements Pb1 and Pb3 in addition to the waveform element Pb2. The waveform element Pb1 is an example of a "first potential change element", the waveform element Pb2 is an example of a "first potential maintenance element", and the waveform element Pb3 is an example of a "second potential change element".

The waveform element Pb1 is an expansion element after the waveform element Pb0. For example, in the waveform element Pb1, the potential of the drive signal COMb changes from the reference potential VC to the potential VLb to drive the piezoelectric element PZ so as to expand the volume of the pressure chamber CV. As described above, since the potential VLb is set to the potential VB or less, the bias of the displacement of the piezoelectric element PZ is reset by the displacement of the piezoelectric element PZ by the waveform element Pb1 before the bias of the displacement of the piezoelectric element PZ is fixed.

The waveform element Pb2 is a maintenance element after the waveform element Pb1. In addition, in the waveform element Pb2, the potential of the drive signal COMb is maintained to drive the piezoelectric element PZ to maintain the volume of the pressure chamber CV expanded by the waveform element Pb1. Therefore, in the waveform element Pb2, the potential of the drive signal COMb is maintained at the potential VLb, which is the potential of the end point of the waveform element Pb1.

The waveform element Pb3 is a contraction element after the waveform element Pb2. For example, in the waveform element Pb3, the potential of the drive signal COMb changes from the potential VLb to the reference potential VC to drive the piezoelectric element PZ to contract the volume of the pressure chamber CV maintained by the waveform element Pb2. The potential change rate of the waveform element Pb3 is set not to discharge the ink in the nozzle N. The potential change rate is the potential change amount per unit time.

In addition, from the viewpoint of suppressing the residual vibration in the next unit period Tu, the potential change rate of the waveform element Pb3 is preferably smaller than the potential change rate of the waveform element Pb1. For example, an absolute value of the change amount in potential per 1 μs of the waveform element Pb1 is preferably equal to or more than 0.15 times and less than 0.35 times an absolute value of a potential difference VAlh between the potential VLa and the potential VHa. In this case, an absolute value of the change amount in potential per 1 μs of the waveform element Pb3 is preferably equal to or more than 0.05 times and less than 0.15 times the absolute value of the potential difference VAlh.

In addition, the potential change rate of the waveform element Pb1 of the drive signal COMb is preferably smaller than the potential change rate of the waveform element Pa1 of the drive signal COMa. For example, an absolute value of the change amount in potential per 1 μs of each of the waveform elements Pa1 and Pa3 of the drive signal COMa is preferably equal to or more than 0.25 times and less than 0.5 times the absolute value of the potential difference VAlh. In this case, for example, the potential change rate of the waveform element Pb1 is more preferably set to be smaller than the potential change rate of the waveform element Pa1 in a range in which the absolute value of the change amount in potential per 1 μs of the waveform element Pb1 is equal to or more than 0.15 times and less than 0.35 times the absolute value of the potential difference VAlh. As a result, it is possible to suppress the discharging of the ink from the nozzle N corresponding to the piezoelectric element PZ to which the drive signal COMb is supplied.

In addition, a length of a period Tb of the waveform element Pb2 is preferably equal to or longer than a length of a period Ta of the waveform element Pa2. In this case, since the period during which the potential of the drive signal COMb that does not discharge the ink is maintained at the potential VLb lower than the potential VB is long, it is possible to prevent the deterioration of the displacement characteristics of the piezoelectric element PZ.

In addition, when the natural vibration cycle of the discharge section D is focused on, the period Tb of the waveform element Pb2 is preferably equal to or more than 0.44 times the natural vibration cycle of the discharge section D. The natural vibration cycle of the discharge section D is, for example, a natural vibration cycle representing the natural vibration cycle of M discharge sections D. For example, the natural vibration cycle representing the natural vibration cycle of the M discharge sections D may be the natural vibration cycle of one discharge section D among the M discharge sections D. Alternatively, the natural vibration cycle representing the natural vibration cycle of the M discharge sections D may be an average value of the natural vibration cycles of the K discharge sections D, or may be a maximum value or a minimum value of the natural vibration cycles of the K discharge sections D. The value K is a natural number satisfying "2 ≤ K ≤ M". When the period Tb of the waveform element Pb2 is long, it is possible to suppress the deterioration of the displacement characteristics of the piezoelectric element PZ as compared with a case where the period Tb of the waveform element Pb2 is short.

In addition, a spacing TC from a center point tc1 of the period of the waveform element Pb1 to a center point tc2 of the period of the waveform element Pb3 is preferably in a range of (n ± 0.2) times the natural vibration cycle of the discharge section D, that is, in a range of equal to or more than (n - 0.2) times and equal to or less than (n + 0.2) times the natural vibration cycle of the discharge section D. n is a natural number of 1 or more. For example, the period of the waveform element Pb1 may be equal to or more than 0.28 times and equal to or less than 0.38 times the natural vibration cycle of the discharge section D, the period of the waveform element Pb2 may be equal to or more than 0.44 times and equal to or less than 0.59 times the natural vibration cycle of the discharge section D, and the period of the waveform element Pb3 may be equal to or more than 0.61 times and equal to or less than 0.81 times the natural vibration cycle of the discharge section D. In the present embodiment, by setting the spacing TC in the range of (n ± 0.2) times the natural vibration cycle of the discharge section D, the residual vibration by the drive signal COMb can be suppressed.

As can be understood from FIG. 5, the potential VB is a potential between the potential VEc corresponding to the coercive electric field of the piezoelectric element PZ and the reference potential VC.

An operation of the liquid discharge apparatus 1 is not limited to the example illustrated in FIG. 5. For example, the pulse PA shown in FIG. 5 is a so-called pull-push-pull waveform, but the pulse PA is not limited to the pull-push-pull waveform. For example, the pulse PA may be a so-called pull-push waveform. In addition, the pulse PB shown in FIG. 5 is a pull-push waveform, but the pulse PB is not limited to the pull-push waveform. In addition, the potential VLb may be the same potential as the potential VLa, or may be a potential different from the potential VLa. However, when the potential VLb is a potential different from the potential VLa, the potential VLb is preferably a potential lower than the potential VLa.

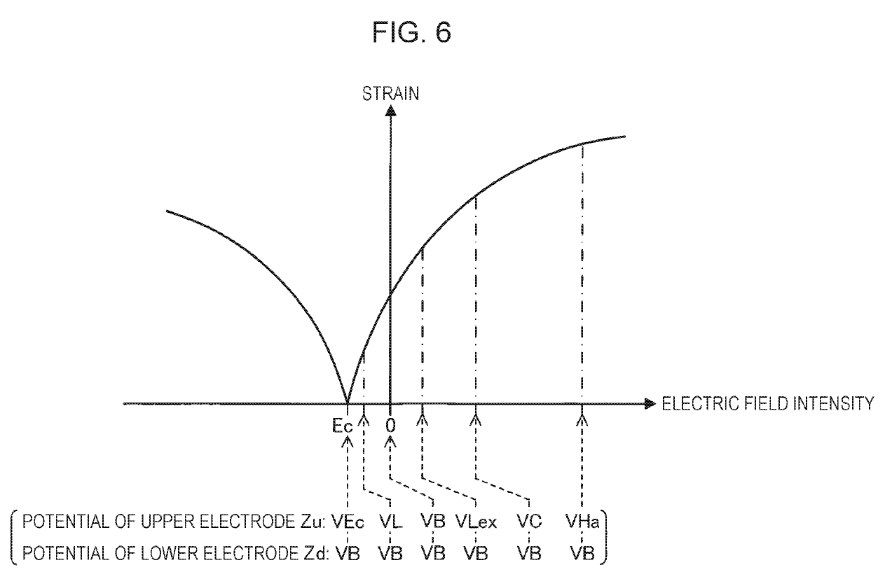

Next, the displacement characteristics of the piezoelectric element PZ will be briefly described with reference to FIG. 6.

FIG. 6 is an explanatory diagram for describing a relationship between a strain of the piezoelectric element PZ and an electric field intensity. A vertical axis of FIG. 6 indicates a strain of the piezoelectric element PZ, and a horizontal axis indicates an electric field intensity between the upper electrode Zu and the lower electrode Zd of the piezoelectric element PZ. For example, the strain of the piezoelectric element PZ corresponds to a displacement amount of the piezoelectric element PZ, and the electric field intensity between the upper electrode Zu and the lower electrode Zd corresponds to a potential difference between the upper electrode Zu and the lower electrode Zd when the lower electrode Zd is a reference. In addition, in FIG. 6, an example of the potential of each of the upper electrode Zu and the lower electrode Zd corresponding to a point having the electric field intensity is shown in parentheses. A reference numeral Ec in FIG. 6 indicates a coercive electric field of the piezoelectric element PZ when the potential VB is supplied to the lower electrode Zd. Hereinafter, the coercive electric field may be referred to as a coercive electric field Ec. In addition, in FIG. 6, a case is assumed in which the potential VLa and the potential VLb are the same potential. Hereinafter, the potentials VLb and VLa may be collectively referred to as a potential VL.

The piezoelectric element PZ has, for example, the displacement characteristics shown in FIG. 6. In the displacement characteristics shown in FIG. 6, when the electric field intensity is higher than the coercive electric field Ec, the strain of the piezoelectric element PZ increases as the electric field intensity increases. However, when the electric field intensity is large, a change amount in the strain of the piezoelectric element PZ with respect to a unit change amount in the electric field intensity is smaller than that when the electric field intensity is small. For example, when the displacement characteristics of the piezoelectric element PZ change due to the imprinting, the graph shown in FIG. 6 is shifted to the left. In this case, for example, the displacement of the piezoelectric element PZ by the pulse PA of the drive signal COMa is small.

Here, as can be understood from FIG. 6, the coercive electric field Ec of the piezoelectric element PZ is a negative value. That is, the potential VEc corresponding to the coercive electric field Ec of the piezoelectric element PZ is a potential lower than the potential VB of the bias voltage signal VBS. In addition, as described with reference to FIG. 5, the potential VB is a potential between the potential VEc and the reference potential VC, and the potential VL is a potential between the potential VB and the potential VEc. That is, when the reference potential VC is supplied to the upper electrode Zu, the electric field intensity is a positive value, and when the potential VL is supplied to the upper electrode Zu, the electric field intensity is a negative value. As described above, in the present embodiment, the polarity of the electric field intensity is reversed between a case where the reference potential VC is supplied to the upper electrode Zu and a case where the potential VL is supplied to the upper electrode Zu. Therefore, for example, the bias of the displacement (polarization) of the piezoelectric element PZ due to the potential of the upper electrode Zu being maintained at the reference potential VC is efficiently reset by the potential VL being supplied to the upper electrode Zu.

In the pulse PBex of the comparative example shown in FIG. 5, the potential VLex, which is the lowest potential of the pulse PBex, is a potential higher than the potential VB. Therefore, when the potential VLex is supplied to the upper electrode Zu, the electric field intensity is a positive value. That is, in the comparative example, the polarity of the electric field intensity is the same between a case where the reference potential VC is supplied to the upper electrode Zu and a case where the potential VLex is supplied to the upper electrode Zu. Therefore, the bias of the displacement of the piezoelectric element PZ due to the potential of the upper electrode Zu being maintained at the reference potential VC may not be reset even when the potential VLex is supplied to the upper electrode Zu.

On the other hand, in the present embodiment, as described above, the bias of the displacement of the piezoelectric element PZ due to the potential of the upper electrode Zu being maintained at the reference potential VC is reset by the potential VL being supplied to the upper electrode Zu. As a result, in the present embodiment, it is possible to suppress the deterioration of the displacement characteristics of the piezoelectric element PZ corresponding to the nozzle N with a low frequency of ink discharging.

As described above, in the present embodiment, the liquid discharge apparatus 1 includes the head unit 3 having the plurality of discharge sections D each including the nozzle N that discharges ink, the pressure chamber CV that communicates with the nozzle N, and the piezoelectric element PZ that applies the pressure fluctuations to the ink in the pressure chamber CV according to the drive signal COM, and the drive signal generation unit 4 that generates the drive signal COM. The piezoelectric element PZ includes the lower electrode Zd to which the bias voltage signal VBS that maintains the potential at the potential VB is supplied, the upper electrode Zu to which the drive signal COM is supplied, and the piezoelectric layer Zm disposed between the lower electrode Zd and the upper electrode Zu. The drive signal COM includes the drive signal COMa that is supplied to the upper electrode Zu of the piezoelectric element PZ of the discharge section D that discharges the ink from the nozzle N, and the drive signal COMb that is supplied to the upper electrode Zu of the piezoelectric element PZ of the discharge section D that does not discharge the ink from the nozzle N. The drive signal COMa includes the waveform element Pa3 which is an element of potential change for displacing the piezoelectric element PZ so that the ink is discharged from the nozzle N. The drive signal COMb includes the waveform element Pb0 that maintains the potential at the reference potential VC, the waveform element Pb1 in which the potential changes from the reference potential VC to the potential VLb, the waveform element Pb1 being an element after the waveform element Pb0, the waveform element Pb2 that maintains the potential at the potential VLb, the waveform element Pb2 being an element after the waveform element Pb1, and the waveform element Pb3 in which the potential changes from the potential VLb to the reference potential VC, the waveform element Pb3 being an element after the waveform element Pb2. The potential VLb is a potential higher than the potential VEc corresponding to the coercive electric field Ec of the piezoelectric element PZ and equal to or lower than the potential VB.

As described above, in the present embodiment, the potential VLb of the drive signal COMb supplied to the discharge section D that does not discharge the ink from the nozzle N is set to a potential higher than the potential VEc corresponding to the coercive electric field Ec of the piezoelectric element PZ, the potential being equal to or lower than the potential VB of the bias voltage signal VBS. As a result, in the present embodiment, it is possible to suppress the period during which the piezoelectric element PZ corresponding to the nozzle N with a low frequency of ink discharging is maintained in the same displacement state as when the reference potential VC is supplied from being long. As a result, in the present embodiment, it is possible to suppress the change in the displacement characteristics of the piezoelectric element PZ corresponding to the nozzle N with a low frequency of ink discharging.

In addition, in the present embodiment, the potential change rate of the waveform element Pb3 may be smaller than the potential change rate of the waveform element Pb1. In the present aspect, since the potential change rate of the waveform element Pb3 of the drive signal COMb in which the potential changes from the potential VLb to the reference potential VC is small, the residual vibration by the drive signal COMb can be suppressed.

In addition, in the present embodiment, the drive signal COMa may further include the waveform element Pa1 in which the potential changes from the reference potential VC to the potential VLa, the waveform element Pa1 being an element before the waveform element Pa3, and the waveform element Pa2 that maintains the potential at the potential VLa, the waveform element Pa2 being an element after the waveform element Pa1. In the present aspect, the potential change rate of the waveform element Pb1 is smaller than the potential change rate of the waveform element Pa1. As a result, in the present aspect, it is possible to suppress the discharging of the ink from the nozzle N corresponding to the piezoelectric element PZ to which the drive signal COMb is supplied.

In addition, in the present embodiment, a length of the period Tb of the waveform element Pb2 may be equal to or longer than a length of the period Ta of the waveform element Pa2. In the present aspect, since the period during which the potential of the drive signal COMb that does not discharge the ink is maintained at the potential VLb lower than the potential VB is long, it is possible to prevent the deterioration of the displacement characteristics of the piezoelectric element PZ.

In addition, in the present embodiment, the spacing TC from the center point tc1 of the period of the waveform element Pb1 to the center point tc2 of the period of the waveform element Pb3 may be in a range of (n ± 0.2) times the natural vibration cycle of the discharge section D. n is a natural number of 1 or more. In the present aspect, since the spacing TC is set in the range of (n ± 0.2) times the natural vibration cycle of the discharge section D, the residual vibration by the drive signal COMb can be suppressed.

In addition, in the present embodiment, the period Tb of the waveform element Pb2 may be equal to or more than 0.44 times the natural vibration cycle of the discharge section D. In the present aspect, since the period during which the potential of the drive signal COMb that does not discharge the ink is maintained at the potential VLb lower than the potential VB is long, it is possible to prevent the deterioration of the displacement characteristics of the piezoelectric element PZ.

### 2. Modification Example

Each embodiment above can be variously modified. Specific modification aspects are illustrated below. Two or more aspects selected in any manner from the following examples can be combined with each other as appropriate within a range not inconsistent with each other. In addition, in the modification examples described below, elements having the same effects and functions as those of the embodiment will be given the reference numerals used in the description above, and each detailed description thereof will be omitted as appropriate.

### First Modification Example

In the above-described embodiment, a case where the liquid discharge apparatus 1 has four head units 3 is exemplified, but the present disclosure is not limited to such an aspect. For example, the liquid discharge apparatus 1 may have the head units 3 the number of which is equal to or greater than 1 and equal to or less than 3, or may have the head units 3 the number of which is equal to or greater than 5. Also in the present modification example, the same effect as in the embodiment described above can be obtained.

### Second Modification Example

In the above-described embodiment and modification example, a case where the liquid discharge apparatus 1 is a serial printer is exemplified, but the present disclosure is not limited to such an aspect. For example, the liquid discharge apparatus 1 may be a so-called line printer in which the plurality of nozzles N are provided in the head unit 3 to extend wider than the width of the recording paper sheet PP. In the present modification example as well, the same effect as in the embodiment and modification examples described above can be obtained.

### 3. Appendices

From the embodiments described above, for example, the following configuration can be ascertained.

A liquid discharge apparatus according to Aspect 1, which is a suitable aspect, includes a liquid discharge head that includes a plurality of discharge sections each including a nozzle that discharges liquid, a pressure chamber that communicates with the nozzle, and a piezoelectric element that applies a pressure fluctuation to the liquid in the pressure chamber in response to a drive signal, and a drive signal generation section that generates the drive signal, in which the piezoelectric element includes a first electrode to which a first signal that maintains a potential at a first potential is supplied, a second electrode to which the drive signal is supplied, and a piezoelectric layer disposed between the first electrode and the second electrode, the drive signal includes a first drive signal that is supplied to the second electrode of the piezoelectric element of the discharge section that discharges the liquid from the nozzle, and a second drive signal that is supplied to the second electrode of the piezoelectric element of the discharge section that does not discharge the liquid from the nozzle, the first drive signal includes a discharge element that is an element of a potential change for displacing the piezoelectric element such that the liquid is discharged from the nozzle, the second drive signal includes a first potential maintenance element that maintains the potential at a reference potential, a first potential change element in which the potential changes from the reference potential to a second potential, the first potential change element being an element after the first potential maintenance element, a second potential maintenance element that maintains the potential at the second potential, the second potential maintenance element being an element after the first potential change element, and a second potential change element in which the potential changes from the second potential to the reference potential, the second potential change element being an element after the second potential maintenance element, and the second potential is equal to or lower than the first potential and higher than a potential corresponding to a coercive electric field of the piezoelectric element.

According to Aspect 1, it is possible to suppress the change in the displacement characteristics of the piezoelectric element corresponding to the nozzle with a low frequency of liquid discharge.

In a liquid discharge apparatus according to Aspect 2, which is a specific example of Aspect 1, a potential change rate of the second potential change element is less than a potential change rate of the first potential change element.

According to Aspect 2, the residual vibration due to the second drive signal can be suppressed.

In a liquid discharge apparatus according to Aspect 3, which is a specific example of Aspect 1 or 2, the first drive signal further includes a third potential change element in which the potential changes from the reference potential to a third potential, the third potential change element being an element before the discharge element, and a third potential maintenance element that is an element after the third potential change element and maintains the potential at the third potential, and a potential change rate of the first potential change element is less than a potential change rate of the third potential change element.

According to Aspect 3, it is possible to suppress the discharging of the ink from the nozzle corresponding to the piezoelectric element to which the second drive signal is supplied.

In a liquid discharge apparatus according to Aspect 4, which is a specific example of any one of Aspects 1 to 3, a length of a period of the second potential maintenance element is equal to or longer than a length of a period of the third potential maintenance element.

According to Aspect 4, the deterioration of the displacement characteristics of the piezoelectric element can be prevented.

In a liquid discharge apparatus according to Aspect 5, which is a specific example of any one of Aspects 1 to 4, a spacing from a center point of a period of the first potential change element to a center point of a period of the second potential change element is in a range of (n ± 0.2) times a natural vibration cycle of the discharge section, and n is a natural number of 1 or more.

According to Aspect 5, the residual vibration due to the second drive signal can be suppressed.

In a liquid discharge apparatus according to Aspect 6, which is a specific example of any one of Aspects 1 to 5, a period of the second potential maintenance element is equal to or more than 0.44 times a natural vibration cycle of the discharge section. According to Aspect 6, the deterioration of the displacement characteristics of the piezoelectric element can be prevented.

A control method of a liquid discharge apparatus according to Aspect 7, which is a suitable aspect, includes a liquid discharge head that includes a plurality of discharge sections each including a nozzle that discharges liquid, a pressure chamber that communicates with the nozzle, and a piezoelectric element that applies a pressure fluctuation to the liquid in the pressure chamber in response to a drive signal, and a drive signal generation section that generates the drive signal, in which the piezoelectric element includes a first electrode to which a first signal that maintains a potential at a first potential is supplied, a second electrode to which the drive signal is supplied, and a piezoelectric layer disposed between the first electrode and the second electrode, the drive signal includes a first drive signal that is supplied to the second electrode of the piezoelectric element of the discharge section that discharges the liquid from the nozzle, and a second drive signal that is supplied to the second electrode of the piezoelectric element of the discharge section that does not discharge the liquid from the nozzle, the first drive signal includes a discharge element that is an element of a potential change for displacing the piezoelectric element such that the liquid is discharged from the nozzle, the second drive signal includes a first potential maintenance element that maintains the potential at a reference potential, a first potential change element in which the potential changes from the reference potential to a second potential, the first potential change element being an element after the first potential maintenance element, a second potential maintenance element that maintains the potential at the second potential, the second potential maintenance element being an element after the first potential change element, and a second potential change element in which the potential changes from the second potential to the reference potential, the second potential change element being an element after the second potential maintenance element, and the second potential is equal to or lower than the first potential and higher than a potential corresponding to a coercive electric field of the piezoelectric element.

According to Aspect 7, the same effect as in Aspect 1 can be obtained.

In a control method of a liquid discharge apparatus according to Aspect 8, which is a specific example of Aspect 7, a potential change rate of the second potential change element is less than a potential change rate of the first potential change element.

According to Aspect 8, the same effect as in Aspect 2 can be obtained.

In a control method of a liquid discharge apparatus according to Aspect 9, which is a specific example of Aspect 7 or 8, the first drive signal further includes a third potential change element in which the potential changes from the reference potential to a third potential, the third potential change element being an element before the discharge element, and a third potential maintenance element that is an element after the third potential change element and maintains the potential at the third potential, and a potential change rate of the first potential change element is less than a potential change rate of the third potential change element.

According to Aspect 9, the same effect as in Aspect 3 can be obtained.

In a control method of a liquid discharge apparatus according to Aspect 10, which is a specific example of any one of Aspects 7 to 9, a length of a period of the second potential maintenance element is equal to or longer than a length of a period of the third potential maintenance element.

According to Aspect 10, the same effect as in Aspect 4 can be obtained.

In a control method of a liquid discharge apparatus according to Aspect 11, which is a specific example of any one of Aspects 7 to 10, a spacing from a center point of a period of the first potential change element to a center point of a period of the second potential change element is in a range of (n ± 0.2) times a natural vibration cycle of the discharge section, and n is a natural number of 1 or more.

According to Aspect 11, the same effect as in Aspect 5 can be obtained.

In a control method of a liquid discharge apparatus according to Aspect 12, which is a specific example of any one of Aspects 7 to 11, a period of the second potential maintenance element is equal to or more than 0.44 times a natural vibration cycle of the discharge section.

According to Aspect 12, the same effect as in Aspect 6 can be obtained.

What is claimed is:

1. A liquid discharge apparatus comprising:
a liquid discharge head that includes a plurality of discharge sections each including a nozzle that discharges liquid, a pressure chamber that communicates with the nozzle, and a piezoelectric element that is configured to apply a pressure fluctuation to the liquid in the pressure chamber in response to a drive signal; and
a drive signal generation section that is configured to generate the drive signal, wherein
the piezoelectric element includes
a first electrode to which a first signal that maintains a potential at a first potential is supplied,
a second electrode to which the drive signal is supplied, and
a piezoelectric layer disposed between the first electrode and the second electrode,
the drive signal includes
a first drive signal that is supplied to the second electrode of the piezoelectric element of the discharge section that discharges the liquid from the nozzle, and
a second drive signal that is supplied to the second electrode of the piezoelectric element of the discharge section that does not discharge the liquid from the nozzle,
the first drive signal includes a discharge element that is an element of a potential change for displacing the piezoelectric element such that the liquid is discharged from the nozzle,
the second drive signal includes
a first potential maintenance element that maintains the potential at a reference potential,
a first potential change element in which the potential changes from the reference potential to a second potential, the first potential change element being an element after the first potential maintenance element,
a second potential maintenance element that maintains the potential at the second potential, the second potential maintenance element being an element after the first potential change element, and
a second potential change element in which the potential changes from the second potential to the reference potential, the second potential change element being an element after the second potential maintenance element, and
the second potential is equal to or lower than the first potential and higher than a potential corresponding to a coercive electric field of the piezoelectric element.

2. The liquid discharge apparatus according to claim 1, wherein
a potential change rate of the second potential change element is less than a potential change rate of the first potential change element.

3. The liquid discharge apparatus according to claim 1, wherein
the first drive signal further includes
a third potential change element in which the potential changes from the reference potential to a third potential, the third potential change element being an element before the discharge element, and
a third potential maintenance element that is an element after the third potential change element and maintains the potential at the third potential, and
a potential change rate of the first potential change element is less than a potential change rate of the third potential change element.

4. The liquid discharge apparatus according to claim 3, wherein
a length of a period of the second potential maintenance element is equal to or longer than a length of a period of the third potential maintenance element.

5. The liquid discharge apparatus according to claim 1, wherein
a spacing from a center point of a period of the first potential change element to a center point of a period of the second potential change element is in a range of (n ± 0.2) times a natural vibration cycle of the discharge section, and n is a natural number of 1 or more.

6. The liquid discharge apparatus according to claim 1, wherein
a period of the second potential maintenance element is equal to or more than 0.44 times a natural vibration cycle of the discharge section.

7. A control method of a liquid discharge apparatus including a liquid discharge head that includes a plurality of discharge sections each including a nozzle that discharges liquid, a pressure chamber that communicates with the nozzle, and a piezoelectric element that is configured to apply a pressure fluctuation to the liquid in the pressure chamber in response to a drive signal, and a drive signal generation section that is configured to generate the drive signal, wherein
the piezoelectric element includes
a first electrode to which a first signal that maintains a potential at a first potential is supplied,
a second electrode to which the drive signal is supplied, and
a piezoelectric layer disposed between the first electrode and the second electrode, the method comprising:
supplying a first drive signal to the second electrode of the piezoelectric element of the discharge section that discharges the liquid from the nozzle, and
supplying a second drive signal to the second electrode of the piezoelectric element of the discharge section that does not discharge the liquid from the nozzle, wherein
the first drive signal includes a discharge element that is an element of a potential change for displacing the piezoelectric element such that the liquid is discharged from the nozzle,
the second drive signal includes
a first potential maintenance element that maintains the potential at a reference potential,
a first potential change element in which the potential changes from the reference potential to a second potential, the first potential change element being an element after the first potential maintenance element,
a second potential maintenance element that maintains the potential at the second potential, the second potential maintenance element being an element after the first potential change element, and
a second potential change element in which the potential changes from the second potential to the reference potential, the second potential change element being an element after the second potential maintenance element, and
the second potential is equal to or lower than the first potential and higher than a potential corresponding to a coercive electric field of the piezoelectric element.
